(19) United States
(12) Patent Application Publication
(10) Pub. No.: US 2010/0038168 A1
(43) Pub. Date: Feb. 18, 2010

(54) Covering Element Comprising a Sound Absorbing Element

(76) Inventors: Rogier Theodorus Siardus Maria Mandos, Roosendaal (NL); William Beens, Steenbergen (NL); Martijn Jacobus De Koning, Ossendrecht (NL)

Correspondence Address: GORDON & REES LLP, 101 WEST BROADWAY, SUITE 1600, SAN DIEGO, CA, 92101, US

(21) Appl. No.: 12/442,931

(22) PCT Filed: Sep. 25, 2007
(86) PCT No.: PCT/NL07/00241

§ 371 Date: Mar. 25, 2009

(30) Foreign Application Priority Data
Sep. 26, 2006 (NL) 1032572

(51) Int. Cl. E04B 1/84; B29C 45/14; B32B 9/04

(52) U.S. Cl. 181/294; 264/267; 428/411.1

(57) ABSTRACT

A method for manufacturing a covering element, including: i) arranging in an injection mould a sound-absorbing element and an adhesive layer, such that the adhesive layer extends over at least apart of an inner surface of the sound-absorbing element; ii) introducing thermoplastic plastic material of increased temperature into the mould at increased pressure, wherein the plastic material spreads over substantially an outer surface of the sound-absorbing element and over a part of the adhesive layer; and iii) cooling the whole such that the thermoplastic plastic material forms a solid carrier element which is adhered to a part of the adhesive layer and wherein the sound-absorbing element is at least partly enclosed between the carrier element and the adhesive layer.

### CROSS REFERENCE TO RELATED APPLICATIONS

This application claims priority from International Patent Application Number PCT/US2007/000241 filed on 25 Sep. 2007 which claims priority from Netherlands Patent Application No. NL/1032572 filed on 26 Sep. 2006.

### TECHNICAL FIELD

The present invention relates to a method for manufacturing a covering element, to a covering element and to the use of the covering element.

### BACKGROUND OF THE INVENTION

In the design and manufacture of vehicles, in particular cars, it is increasingly important that the sounds produced by the vehicle and sounds originating from outside, caused for instance by road chippings against the underside of the car, are absorbed or damped. The decrease in the noise impact of a vehicle has the advantageous effect, among others, that the passenger comfort is improved. In addition, passengers get tired less quickly. Another favourable effect is that the noise impact in the vicinity of the vehicle is reduced.

At the moment however, many parts of a vehicle are manufactured from plastic. This is because the use of plastic has a number of advantages over the use of metal. One of the most important properties of the use of plastics is that components can be given a lighter form. Plastic covering elements, i.e. elements which can be used in the manufacture of vehicles, are used in many different places in vehicles, such as for instance in the engine part, as outer surface, but also in the interior of the vehicle.

A drawback of the use of plastic parts on for instance the underside of a car is that, without a sound-absorbing element, they tend to act as a so-called soundbox. The sounds produced by the vehicle are in this case amplified by the plastic parts. This is not desirable. In order to obviate this problem plastic parts can be provided with sound-absorbing elements. The arranging of such elements is however labour-intensive, which results in higher production costs.

The sound-absorbing elements are fixedly connected here to the plastic parts. A drawback hereof is that, when the vehicle is scrapped, or at least disassembled, the sound-absorbing elements are difficult to separate from the plastic parts. Under the terms of the increasingly strict environmental regulations in respect of the scrapping and processing of vehicles, it is however necessary to separate the sound-absorbing elements from the plastic parts. However, because the elements are fixedly connected to the plastic parts, separating the elements from the plastic parts is not possible, or hardly so, and the costs of processing the vehicle become higher.

Known from the international patent application PCT/NL2006/000070 is a fibre-reinforced covering element and a method for manufacturing such a covering element. In the covering element described in this application the sound-absorbing elements are not fixedly connected to the other plastic parts. The sound-absorbing element can easily be separated from the other parts during scrapping of the vehicle. The use of fibre-reinforced material is however relatively expensive and fibre-reinforced materials have to be further processed, i.e. burrs and the like have to be removed. The end products are further relatively heavy due to the fibres used, and this may be undesirable in determined applications.

The present invention has for its object to provide a solution for the above stated problems.

### SUMMARY OF THE INVENTION

A first aspect of the present invention relates for this purpose to a method for manufacturing a covering element, comprising of:

i) arranging in an injection mould a sound-absorbing element and an adhesive layer, such that the adhesive layer extends over at least a part of the inner surface of the sound-absorbing element;

ii) introducing thermoplastic plastic material of increased temperature into the mould at increased pressure, wherein the plastic material spreads over substantially the outer surface of the sound-absorbing element and over a part of the adhesive layer;

iii) cooling the whole such that the thermoplastic plastic material forms a solid carrier element which is adhered to a part of the adhesive layer and wherein the sound-absorbing element is at least partly enclosed between the carrier element and the adhesive layer.

The outer surface of the sound-absorbing element is here the side of the sound-absorbing element directed toward the thermoplastic plastic material which is introduced into the injection mould and which after cooling forms the solid carrier element. The inner surface is the other side of the sound-absorbing element.

An advantage of using this method is that covering elements can be manufactured in relatively easy manner and with high speed and precision. Because the sound-absorbing element is not connected to the adhesive layer and/or the carrier element, the sound-absorbing element can further be removed relatively easily when the vehicle is scrapped. This has a favourable effect on the environmental impact.

Another advantage is that using such an injection moulding method a covering element can be manufactured which has no or only little fibre material. The cost of the covering element is hereby lower. Injection moulding has the further advantage that no further processing of the material is required. Complex forms can also be obtained and so-called undercuts can be created. In addition, the products obtained by means of injection moulding are often lighter, because no fibres are required to make the whole manageable, this being particularly important in the case of so-called compression moulding.

It is recommended that in step ii) the thermoplastic plastic material is introduced into the mould at a (cavity) pressure in the range of 200 to 400 bar.

The thermoplastic plastic material preferably has a temperature in step ii) lying in the range of 150° C. to 300° C., more preferably in the range of 190° C. to 250° C.

The adhesive layer preferably extends over substantially the whole surface of the sound-absorbing element in step i) such that the sound-absorbing element is enclosed substantially in its entirety between the carrier element and the adhesive layer when steps ii) and iii) are performed. An advantage hereof is that there is less chance of the sound-absorbing element displacing during use of the vehicle provided with the covering element according to the invention. An additional advantage is that the sound-absorbing element is better protected from outside influences such as for instance oil products and coolant.

It is further recommended that the adhesive layer is a foil. The advantage of a foil is that it forms a very good barrier against outside substances such as oil products or coolant. Through the use of a foil a relatively good protection is thus obtained from substances which are used in vehicles such as cars and aircraft, and which can act on the sound-absorbing element, whereby the properties of this element deteriorate.

In another recommended embodiment the adhesive layer comprises a fleece. Owing to the relatively open structure thereof, a fleece already has good sound-absorbing properties per se. A very good sound-absorption of the covering element is thus obtained by using fleece in combination with the sound-absorbing element.

It is further recommended that a second adhesive layer is arranged on the covering element in addition to the above described adhesive layer, this second adhesive layer being situated between the sound-absorbing element and the carrier element. The advantage of this second adhesive layer is that, when a recess is arranged in the sound-absorbing element, the thermoplastic plastic material cannot move under the sound-absorbing element. This avoids a part of the sound-absorbing element coming to lie in the case of a number of elements on the wrong side of the carrier element during manufacture of the covering element.

The thermoplastic plastic material preferably comprises a polyolefin. It is however particularly recommended that the plastic material is polyamide, polypropylene or polyethylene. The use of these materials is advantageous because they allow easy forming into a desired shape and because they have very good mechanical properties after forming.

It is recommended that the sound-absorbing element and the adhesive layer are combined outside the mould and placed as total package into the mould. An advantage hereof is that fewer operations are necessary, and this has a favourable effect on the production costs. The sound-absorbing element is further prevented from being wrongly positioned relative to the adhesive layer.

In order to further strengthen the covering element, the thermoplastic plastic material comprises fibres. The fibre percentage in the thermoplastic plastic material of the carrier element preferably lies in the range of 0 to 50% by weight, preferably 10 to 40% by weight, more preferably about 30% by weight.

The fibres preferably comprise glass fibres and/or basalt fibres and/or natural fibres. When the fibres comprise natural fibres, it is then recommended that they comprise hemp fibres, banana fibres, coconut fibres and/or flax fibres. The use of natural fibres has the advantage that they are environmentally-friendly. An additional advantage is that they are easy to process, are relatively low in price and do not leave any residual products (slag) in thermal recycling.

It is further recommended that the sound-absorbing element comprises an open-cell structure. Such a structure generally has a very good sound-absorbing capacity, whereby it is suitable for absorbing vehicle sounds.

In a recommended embodiment the sound-absorbing element has an open-cell structure. The open-cell structure preferably comprises foam material. The foam material is preferably preformed in two-dimensional or three-dimensional manner, and can preferably be removed from a roll. The advantage of foam material is that different thicknesses and different materials can be used. The advantage hereof is that the sound absorption in a determined range can be improved by for instance using a thicker or more compact foam. It is also possible to arrange multiple layers of the same foam on top of each other. It is also possible to combine different types of foam with each other, such that a desired degree of sound absorption or damping is obtained. It is further recommended that the foam material comprises polyurethane.

The sound-absorbing element can also be manufactured from a felt-like material, glass wool or rock wool. It is herein noted that a combination with for instance foam material as described above is also possible here.

In a recommended embodiment the sound-absorbing element comprises a plurality of separate parts with differing sound-absorbing properties. The parts can for instance be stacked on top of each other here so that an element is obtained with a desired degree of sound absorption. It is thus possible to adjust the sound-absorbing properties subject to the position at which the covering element is placed. This makes the covering element very widely applicable.

The sound-absorbing element can be provided with openings through which the adhesive layer is adhered to the carrier element during the manufacture of the covering element. This ensures that the sound-absorbing element remains properly positioned at the same position during its lifespan, and that the chance of it shifting during use is reduced. The use of such openings in the sound-absorbing element is particularly advantageous when the sound-absorbing element comprises a relatively large surface area. It is further also possible for smaller openings to be arranged during manufacture in the area where the adhesive layer is adhered to the carrier element, i.e. the openings are arranged in the adhesive layer and the carrier element. Such smaller openings can be used to discharge water which could get onto the covering element during use of the covering element in a vehicle.

It is recommended that the adhesive layer comprises a thermoplastic plastic material, preferably polypropylene. It is however further recommended that the adhesive layer comprises substantially the same thermoplastic material as the thermoplastic plastic material of the carrier element. It is here also recommended that this is polypropylene.

In a recommended embodiment the adhesive layer is impregnated with a water-repellent, oil product-repellent and/or fuel-repellent agent. Such an impregnation is advantageous since many of the oil products, such as lubricating oil, hydraulic oil, brake fluid, engine oil and other substances such as cooling agents, hydraulic liquids and fuels, used in the vehicle industry, such as the car and aircraft industry, can affect the quality of the adhesive layer or even penetrate the sound-absorbing element. This has an adverse effect on the lifespan of the covering element, as well as on the sound-absorbing properties of the element.

It is further recommended that a thermostable element is arranged between the inner surface of the sound-absorbing element and the adhesive layer and/or on the outer surface of the sound-absorbing element.

The thermostable element ensures that the sound-absorbing element does not adhere to the carrier element and/or the adhesive layer during the manufacture of the covering element. The thermostable elements find particular application with sound-absorbing elements which are not thermostable, or hardly so, i.e. they for instance melt, decompose or otherwise lose their three-dimensional structure under the influence of heat. The thermostable layer can further be chosen such that it makes an additional contribution toward absorption of sound. The use of such a thermostable layer is however not essential to the invention.

It is recommended that the thermostable element is integrated with the sound-absorbing element. This makes manufacture of the covering element simpler and the elements are prevented from shifting relative to each other during use. A foam material is preferably used on which the thermostable element is arranged as a covering.

In a preferred embodiment a part of the covering element is provided with a heat-resistant element, preferably an aluminium element. The heat-resistant element can herein be arranged on only one side of the covering element but also on both sides, i.e. on both the carrier element and the adhesive layer. The heat-resistant element is preferably arranged at a position on the covering element where no sound-absorbing element is arranged. In some circumstances it may however be desirable to also arrange the heat-resistant element at locations on the covering element where a sound-absorbing element is positioned.

In an embodiment of the present invention the covering element is substantially flat. Such flat elements are generally applied in the automobile industry as protective plate for the engine and/or the underside of the car. The elements can however also be used on the inside of the car. Such elements can further also be used in the aviation industry in particular.

It is recommended that the fibre-reinforced thermoplastic plastic material of the carrier element comprises a glass mat-reinforced thermoplastic (GMT) or a long fibre-reinforced thermoplastic (LFT). These composite materials are mostly used in the automobile industry, wherein the plastic material usually comprises polypropylene.

In a particular embodiment according to the present invention a carpet material is also placed in the mould in step i) in addition to a sound-absorbing element and an adhesive layer. The carpet material is preferably arranged on the outer side of the adhesive layer or on the outer side of the carrier element to be formed. This latter can be achieved by arranging an opening in the carpet material through which the injector of the injection moulding machine enters the mould. The thermoplastic plastic material is thus arranged between the sound-absorbing element in the carpet layer. The carpet layer adheres to the thermoplastic plastic material (the sound-absorbing element not) and a covering element is thus obtained which is provided on at least one side with carpet material and on the other side with the sound-absorbing element. This carpet material can serve as carpet, for instance the interior of a car, but can also be used to reduce the noise from road chippings. It is noted that carpet material can also be arranged when use is made of a pressure mould as described in the prior art. The carpet material is then for instance set into the soft carrier element with the sound-absorbing element in the adhesive layer of thereunder.

A second aspect of the present invention relates to a covering element obtainable with the method as described above.

A third aspect of the present invention relates to a covering element comprising a carrier element of thermoplastic plastic material, at least one sound-absorbing element extending over at least a part of the surface of the carrier element, and an adhesive layer extending over and beyond at least a part of the surface of the sound-absorbing element, wherein at least a part of the adhesive layer is adhered to the carrier element such that the sound-absorbing element is at least partly enclosed between the adhesive layer and the carrier element, with the proviso that the thermoplastic plastic material of the carrier material is not fibre—reinforced.

An advantage of such a covering element is that, when the vehicle is scrapped, the sound-absorbing element can be separated easily and integrally from the carrier element. It is after all only necessary to remove or cut open the adhesive layer in order to remove the sound-absorbing element. This has a favourable effect on the environmental impact of the vehicle, as well as on the cost of scrapping or at least disassembling the vehicle.

A further advantage is that the covering element in many cases has better acoustic properties than a covering element in which the sound-absorbing element is adhered to the carrier element. The covering element according to the invention further provides the option in simple manner of using sound-absorbing elements with different sound-absorbing properties, depending on the position at which the covering element is placed in a vehicle. A covering element placed in the vicinity of the engine does after all generally require a greater sound-absorbing capacity than a covering element placed in the vicinity of the wheels.

Another advantage of the covering element according to the invention is that the wall thickness of the covering element is negligibly greater at the positions where no sound-absorbing element is arranged than the wall thickness of a plate without sound-absorbing element.

A covering element wherein the carrier element is manufactured from non-fibre-reinforced material has the further advantage of having a lower density than fibre-reinforced material. It thus has a lower part-wait at an equal wall strength. The covering element wherein the carrier element is not fibre-reinforced can further have a relatively complex form.

The sound-absorbing element is preferably arranged on both sides of the carrier element. This can be achieved with an injection moulding method as well as with a pressing method. It is also possible for the carrier element to be fibre-reinforced.

A fourth aspect of the present invention relates to a vehicle covering element comprising a covering element as described above.

A final aspect of the present invention relates to the use of a covering element as described above for covering a vehicle, preferably a car or an aircraft.

### BRIEF DESCRIPTION OF THE DRAWINGS

Mentioned and other features of the covering element and the method for manufacturing the covering element according to the invention will be further elucidated hereinbelow on the basis of a number of exemplary embodiments, which are only given by way of example and without the invention being deemed limited thereby, Reference is made herein to the accompanying drawings, in which:

FIG. 1 shows a view of an embodiment of a method for manufacturing an embodiment of a covering element according to the invention;

FIG. 2 shows a view of the injection mould of FIG. 1 for manufacturing an embodiment of a covering element, in addition to an embodiment of a covering element according to the invention;

FIG. 3 shows a view of an injection mould according to an embodiment of the present invention for manufacturing a covering element, in addition to an embodiment of a covering element according to the invention;

FIG. 4 shows a side view of a covering element according to an embodiment of the invention;

FIG. 5 shows a view of a covering element according to an embodiment of the invention;

FIG. 6 shows in detail a drainage part of an embodiment of a covering element according to the invention;

FIG. 7 is a side view of a covering element provided with a heat-resistant element;

FIG. 8 shows a view with exploded parts of an embodiment of a covering element according to the invention.

### DETAILED DESCRIPTION OF THE DRAWINGS

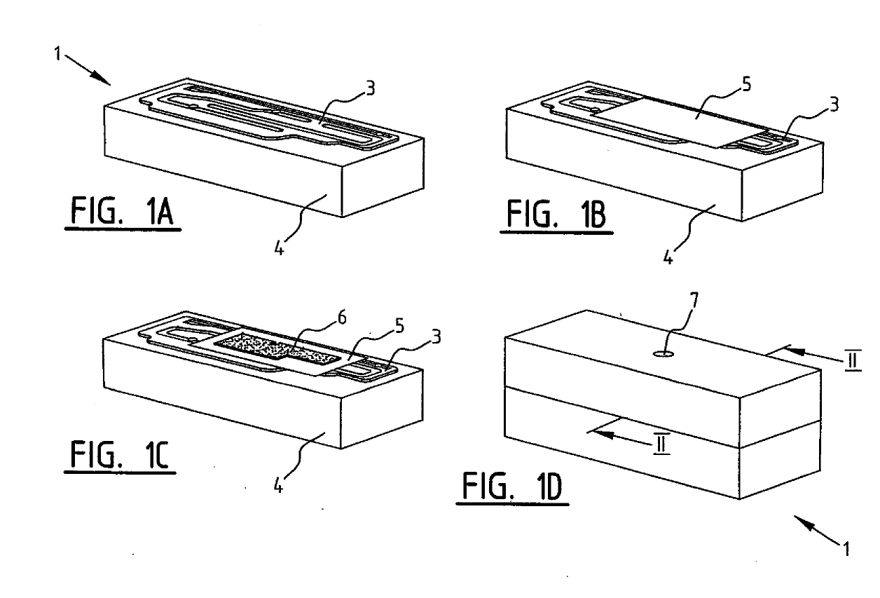

FIG. 1A shows apart of an injection mould 1 for manufacturing a covering element 2. The mould part comprises a forming part 3 for forming a covering element 2, and further comprises a metal core 4. FIG. 1B shows the application of an adhesive layer 5 of thermoplastic plastic material, preferably polypropylene, to forming part 3 of mould part 1. A sound-absorbing element 6 is arranged on this adhesive layer 5 as shown in FIG. 1C. It is noted here that in this embodiment the injection mould is positioned horizontally in order to facilitate the introduction of the adhesive layer and the sound-absorbing element. It is however also possible to position the injection mould vertically. The mould is then preferably provided with means for positioning the adhesive layer and the sound-absorbing element. Sound-absorbing element 6 of FIG. 1C preferably comprises a polyurethane foam structure. Depending on the position of the covering element on the vehicle, preferably a car, the foam layer is thinner or thicker, or more compact, or consists of layers of a different sound-absorbing material.

Once adhesive layer 5 and sound-absorbing element 6 have been placed into mould 1, the injection mould closes fully as shown in FIG. 1D. Once mould 1 is closed, thermoplastic plastic material for the carrier element to be formed is introduced into the closed mould via opening 7 at an increased temperature and pressure, i.e. about 200° C. and a (cavity) pressure of between 200 and 400 bar. Owing to the high pressure the liquid plastic material flows out over the outer side of the sound-absorbing element and over the adhesive layer and presses these into the form of the mould. At the locations where the hot thermoplastic material contacts adhesive layer 5, this latter will fuse to the thermoplastic plastic material for the carrier element. The sound-absorbing element does not however fuse to the adhesive layer or the thermoplastic plastic material for the carrier element. Because adhesive layer 5 extends over sound-absorbing element 6, during pressing the sound-absorbing element 6 will be enclosed between the adhesive layer and carrier element 7 without sound-absorbing element 6 being connected to the carrier element. Although the sound-absorbing element will be compressed during the introduction of the thermoplastic plastic material via opening 7, it regains its shape after the processing. Once the whole has cooled a covering element is thus obtained which is durably provided with a sound-absorbing element. It is recommended here that the formed carrier element not be fibre-reinforced, which has a favourable effect in respect of costs.

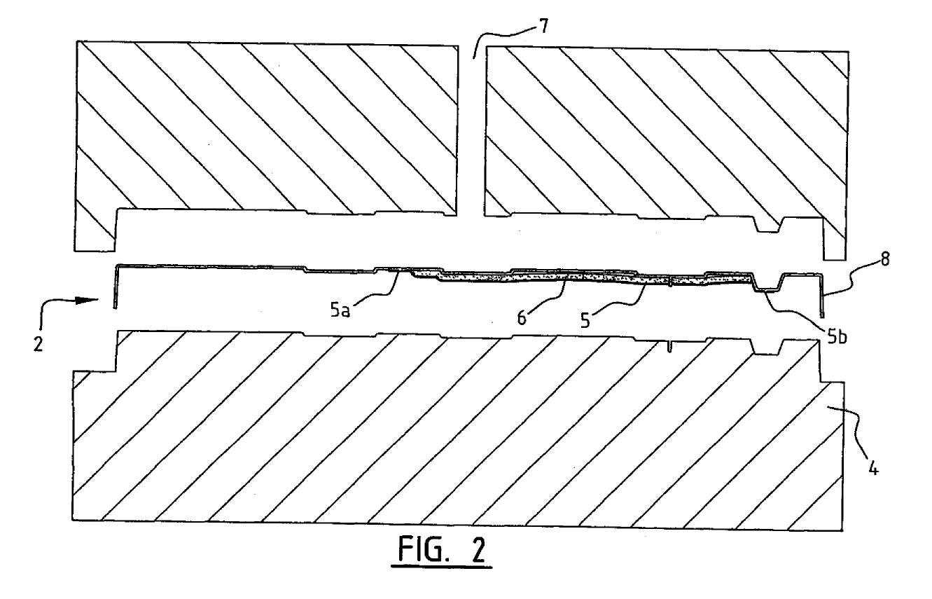

FIG. 2 shows in cross-section the injection mould opened to some extent once the covering element has been manufactured by means of introducing thermoplastic plastic material via opening 7 in mould 4. Covering element 2 comprises a carrier element 8 to which adhesive layer 5 is attached by means of fusing 5a, 5b. Sound-absorbing element 6 is herein enclosed between adhesive layer 5 and carrier element 8 such that it can no longer shift during use of covering element 2 in a vehicle.

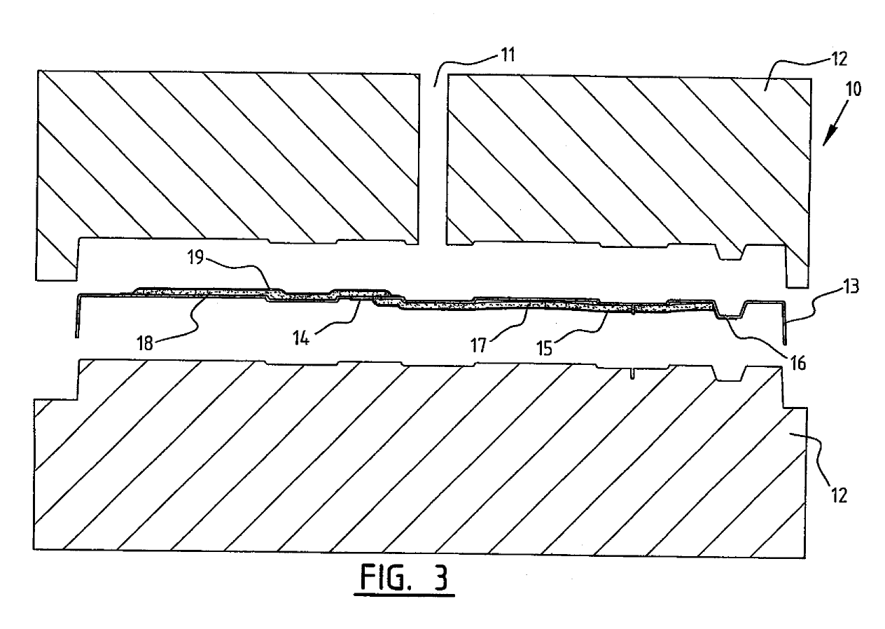

FIG. 3 shows a preferred embodiment of the present invention. In this embodiment the injection mould 10 is opened to some extent once the covering element has been manufactured by introducing thermoplastic plastic material through opening 11 in mould 12 at increased temperature and pressure. Covering element 13 comprises a carrier element 14 to which a first adhesive layer 15 is attached by means of fusing 16. A first sound-absorbing element 17 is herein enclosed between first adhesive layer 15 and carrier element 14 such that it can no longer shift during use of covering element 13 in a vehicle. The covering element further also comprises a second sound-absorbing element 18 which is enclosed between carrier element 14 and a second adhesive layer 19. Thus is achieved that sound-absorbing material is arranged on two sides of the carrier element.

FIG. 4 shows a cross-section of covering element 13 of FIG. 3. Covering element 13 comprises carrier element 14 on which the first sound-absorbing element 17 is arranged. This sound-absorbing element 17 is held in place by means of the first adhesive layer 15 applied thereover. At least a portion 15a of this first adhesive layer extends beyond the first sound-absorbing element 17. During manufacture of covering element 13 this portion 15a has come into contact with the thermoplastic plastic material which has formed carrier element 14 and has been fused thereto. The first sound-absorbing element 17 is thus enclosed between first adhesive layer 15 and carrier element 14. A second sound-absorbing element 18 is further also arranged which is enclosed between a second adhesive layer 19 and the carrier element. Thus is achieved that the covering element is provided with a sound-absorbing element on two sides. It is further also possible to arrange carpet material on the covering element in order to prevent noise caused by, among other things, road chippings.

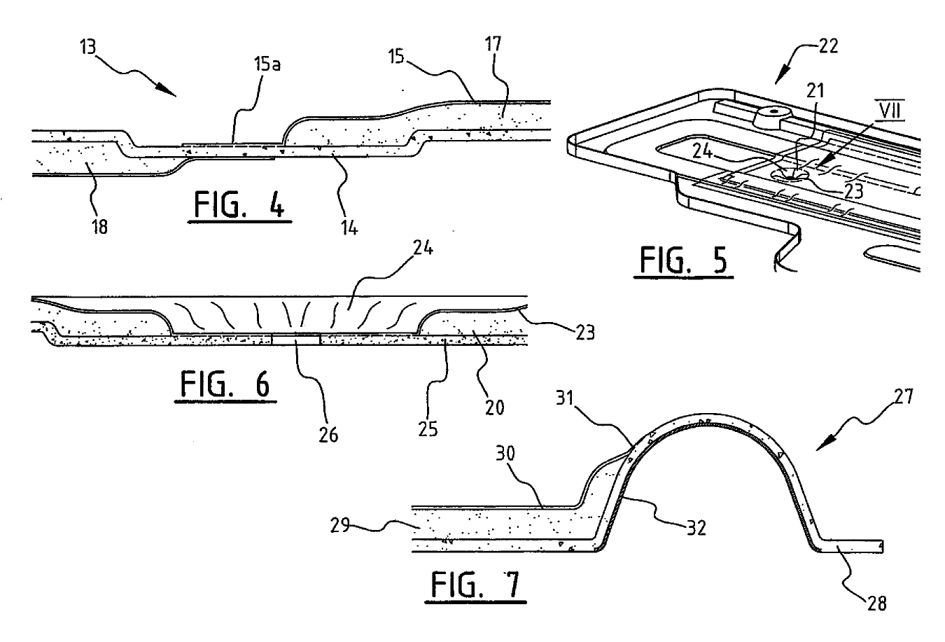

FIGS. 5 and 6 show an embodiment of the present invention wherein sound-absorbing element 20 is provided with an opening 21. Because this opening 21 is present in sound-absorbing element 20, adhesive layer 23 is adhered to the carrier element in this opening 21 during manufacture of covering element 22, thus defining a dish 24. The advantage of such a dish 24 is that sound-absorbing element 20 cannot shift during use of covering element 22 in a vehicle. Another advantage of this embodiment is that an opening 26 can be arranged in the dish which extends through the carrier element, so that dish 24 can be used to drain liquids such as for instance water. Carrier element 25 preferably comprises polypropylene and is not fibre-reinforced.

FIG. 7 shows a covering element 27 according to an embodiment of the present invention. Covering element 27 comprises a carrier element 28 of polypropylene which is not fibre-rein forced and on which a sound-absorbing element 29 is arranged. An adhesive layer 30 is applied over this sound-absorbing element 29. This adhesive layer 30 is fused to carrier element 28 at a portion 31 extending beyond sound-absorbing element 29. A part of carrier element 28 is further provided with a heat-resistant element 32. This heat-resistant element 32 ensures that covering element 27 can be applied in the vicinity of a heat source, such as for instance an exhaust system (not shown), without carrier element 28, sound-absorbing element 29 or adhesive layer 30 disintegrating, or at least melting or becoming soft. It is however also possible to provide adhesive layer 30 and/or carrier element 28 with a heat-resistant element 32, such as for instance an aluminium plate. Heat-resistant element 32 can here also extend over the area where a sound-absorbing element is arranged.

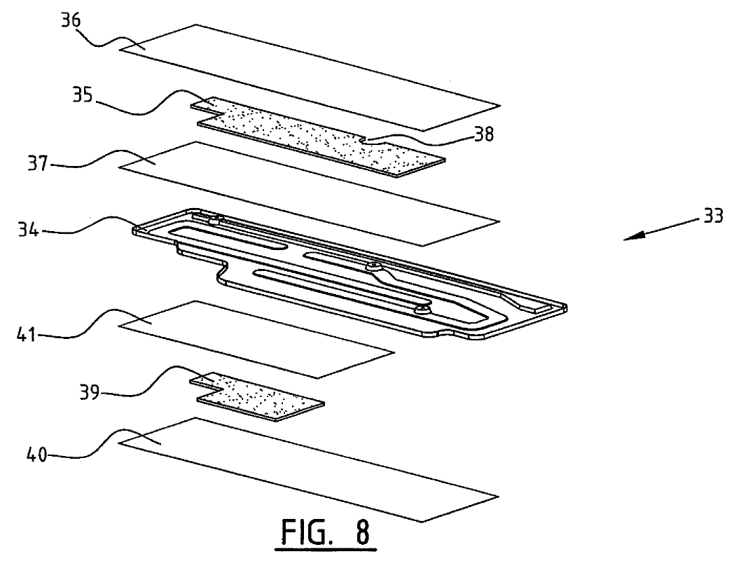

FIG. 8 shows a covering element 33 according to an embodiment of the present invention in exploded parts. Covering element 33 comprises a carrier element provided with a desired shape. Covering element 33 further comprises a first sound-absorbing element 35 of for instance polyurethane foam. A first and a second adhesive layer 36, 37 are further shown. The first adhesive layer 36 extends beyond the surface of first sound-absorbing element 35. At the locations where adhesive layer 36 contacts carrier element 34 they are fused to each other (or to the second adhesive layer 37) such that sound-absorbing element 35 is enclosed therebetween. Adhesive layer 36 and sound-absorbing element 35 herein substantially follow the form of carrier element 34. The second adhesive layer 37 is situated between sound-absorbing element 35 and carrier element 34. Making use of this second adhesive layer 37 prevents the thermoplastic plastic material of the carrier element 34 to be formed coming to lie on the top side of sound-absorbing element 35 at the position of recess 38 during the manufacture of covering element 33 by injection-moulding. At the locations where the second adhesive layer 37 does not contact the sound-absorbing element it is fused to carrier element 34. It is further also possible to adhere the first adhesive layer 36 to the second adhesive layer 37 beforehand, such that a package is formed in which sound-absorbing element 35 is enclosed. And, during manufacture, to place the package in the mould, to close the mould and introduce the thermoplastic plastic material into the mould at high pressure and temperature. Covering element 33 is further provided with a second sound-absorbing element 39. This element 39 is also enclosed by two adhesive layers 40 and 41, these adhesive layers having the same effect as the above stated adhesive layers 36, 37.

The present invention is not limited to the above described embodiments, the rights sought rather being defined by the following claims, within the scope of which many possible modifications can be envisaged, such as among others a combination of the above described embodiments.

What is claimed:

1. A method for manufacturing a covering element, comprising:
i) arranging in an injection mould a sound-absorbing element and an adhesive layer, such that the adhesive layer extends over at least a part of an inner surface of the sound-absorbing element;
ii) introducing thermoplastic plastic material of increased temperature into the mould at increased pressure, wherein the plastic material spreads over substantially an outer surface of the sound-absorbing element and over a part of the adhesive layer; and
iii) cooling the whole such that the thermoplastic plastic material forms a solid carrier element which is adhered to a part of the adhesive layer and wherein the sound-absorbing element is at least partly enclosed between the carrier element and the adhesive layer.

2. The method as in claim 1, wherein in step ii) the thermoplastic plastic material is introduced into the mould at a pressure in the range of 200 to 400 bar.

3. The method as in either of claim 1 or 2, wherein in step ii) the thermoplastic plastic material has a temperature in the range of 150° C. to 300° C., preferably 190° to 250° C.

4. The method as in claim 1, wherein the adhesive layer extends over substantially the whole surface of the sound-absorbing element in step i) such that the sound-absorbing element is enclosed substantially in its entirety between the carrier element and the adhesive layer when step ii) and iii) are performed.

5. The method as in claim 1, wherein the adhesive layer is a foil or fleece.

6. The method as in claim 1, wherein in step i) the sound-absorbing element is arranged between two adhesive layers in the mould.

7. The method as in claim 1, wherein the thermoplastic plastic material comprises a polyolefin, preferably polypropylene, polyamide or polyethylene.

8. The method as in claim 1, wherein the sound-absorbing element and the adhesive layer are combined outside the mould, and placed as total package into the mould.

9. The method as claim 1, wherein the thermoplastic plastic material is fibre-reinforced.

10. The method as in claim 9, wherein the fibre-reinforced thermoplastic material has a fibre percentage in the range of 0 to 50%, preferably 10 to 40%, more preferably about 30%.

11. The method as in claim 9 or 10, wherein the fibres comprise glass fibres and/or basalt fibres and/or natural fibres.

12. The method as in claim 9, wherein the natural fibres comprise hemp fibres, banana fibres, coconut fibres and/or flax fibres.

13. The method as in claim 1, wherein the sound-absorbing element comprises an open-cell structure.

14. The method as in claim 13, wherein the open-cell structure comprises a foam material, preferably polyurethane.

15. The method as in claim 13 or 14, wherein the sound-absorbing element comprises felt-like material, glass wool or rock wool.

16. The method as in claim 1, wherein the adhesive layer comprises the same thermoplastic material as the thermoplastic plastic material, preferably polypropylene.

17. The method as in claim 1, wherein the adhesive layer is impregnated with an oil-repellent and/or fuel-repellent agent.

18. The method as in claim 1, wherein a thermostable element is arranged between the inner surface of the sound-absorbing element and the adhesive layer and/or on the outer surface of the sound-absorbing element.

19. The method as claim 19, wherein the thermostable element and the sound-absorbing element are integrated.

20. The method as in claim 1, wherein a part of the covering element is provided with a heat-resistant element, preferably an aluminium element.

21. The method as in claim 1, wherein the thermoplastic plastic material is a glass mat-reinforced thermoplastic (GMT) or a long-fibre thermoplastic (LFT).

22. The method as in claim 1, wherein the sound-absorbing element is provided with openings such that the adhesive layer is adhered to the carrier element via these openings.

23. The method as in claim 1, wherein the sound-absorbing element comprises a plurality of separate parts.

24. The method as in claim 23, wherein the sound-absorbing element comprises a plurality of separate parts with differing sound-absorbing properties.

25. The method as in claim 1, wherein carpet material is placed in the mould in step i).

26. A covering element obtainable in accordance with the method of claims 1.

27. A covering element of thermoplastic plastic material, comprising a carrier element of thermoplastic plastic material, at least one sound-absorbing element extending over at least a part of the surface of the carrier element, and an adhesive layer extending over and beyond at least a part of the surface of the sound-absorbing element, wherein at least a part of the adhesive layer is adhered to the carrier element such that the sound-absorbing element is at least partly enclosed between the adhesive layer and the carrier element, and wherein the thermoplastic plastic material of the carrier material is not fibre-reinforced.

28. The covering element of claim 27, wherein the sound-absorbing element is enclosed substantially wholly by the adhesive layer and the carrier element.

29. The covering element of claim 27 or 28, wherein the adhesive layer is a foil or a fleece.

30. The covering element of claim 28 or 29, wherein a second adhesive layer is arranged between the sound-absorbing element and the carrier element.

31. The covering element of claim 27, wherein carpet material is arranged on at least a part of the inner and/or outer side of the carrier material.

32. The covering element of claim 27, wherein the thermoplastic plastic material is a polyolefin, preferably polypropylene, polyamide or polyethylene.

33. The covering element of claim 27, wherein the sound-absorbing element 5 comprises an open-cell structure.

34. The covering element of claim 33, wherein the open-cell structure comprises a foam material, preferably polyurethane.

35. The covering element of claim 27, wherein the sound-absorbing element comprises felt-like material, glass wool or rock wool.

36. The covering element of claim 27, wherein the sound-absorbing element comprises separate parts with differing sound-absorbing properties.

37. The covering element of claim 27, wherein the sound-absorbing element is provided with openings such that tire adhesive layer is adhered to the carrier element via the openings.

38. The covering element of claim 27, wherein the adhesive layer comprises the same thermoplastic material as the thermoplastic plastic material of the carrier element, preferably polypropylene.

39. The covering element of claim 27, wherein the adhesive layer is impregnated with an oil-repellent and/or fuel-repellent agent.

40. The covering element of claim 27, wherein a thermostable element is arranged between the carrier element and the sound-absorbing element and/or between the adhesive layer and the sound-absorbing element.

41. The covering element of claim 40, wherein the thermostable element and the sound-absorbing element are integrated.

42. The covering element of claim 27, wherein a part of the covering element is provided with a heat-resistant element, preferably an aluminium element.

43. The covering element of claim 27, wherein the covering element is substantially flat.

44. The covering element of claim 27, wherein the covering element is a vehicle covering element.

45. The covering element of claim 44, wherein the covering element is used for covering a car or aircraft.
